(19) United States
(12) Patent Application Publication
(10) Pub. No.: US 2001/0005363 A1
(43) Pub. Date: Jun. 28, 2001

(54) AV apparatus, method of controlling an AV apparatus, and AV-apparatus network system

(76) Inventor: Teruo Tajima, Sawa-gun (JP)

Correspondence Address: Pillsbury Madison & Sutro, LLP, Ninth Floor, East Tower, 1100 New York Avenue, N.W., Washington, DC, 20005-3918, US

(21) Appl. No.: 09/741,872

(22) Filed: Dec. 22, 2000

(30) Foreign Application Priority Data
Dec. 24, 1999 (JP) 11-367918

(51) Int. Cl. G06F 13/00; H04L 12/28

(52) U.S. Cl. 370/257; 710/104

(57) ABSTRACT

The present invention relates to an AV apparatus having a plurality of connection terminals to which a plurality of apparatuses can be selectively connected and designed to control the apparatuses connected to the connection terminals. In the AV apparatus, identifiers are allocated to the connection terminals, respectively, each for designating a specific one of the apparatuses so that the apparatuses connected to the connection terminals are controlled in a priority order.

### CROSS-REFERENCE TO RELATED APPLICATIONS

This application is based upon and claims the benefit of priority from the prior Japanese Patent Application No. 11-367918, filed Dec. 24, 1999, the entire contents of which are incorporated herein by reference.

### BACKGROUND OF THE INVENTION

The present invention relates to an AV apparatus that can be connected to another apparatus by a digital interface that complies with the IEEE (the Institute of Electrical and Electronic Engineers, Inc.) 1394 standards. The invention also relates to a method of controlling such an AV apparatus and an AV-apparatus network system.

AV apparatuses may be connected together by serial buses that uses digital interface that comply with the IEEE 1394 standards. As known in the art, the topology of connecting AV apparatuses by such serial buses has a high degree of design. Further, the connection and disconnection of AV apparatuses by such serial can achieve hot swap.

To achieve the hot swap, an algorithm generates a bus-reset signal when a cable is connected to an AV apparatus or disconnected therefrom. Thus, the bus-reset signal indicates that the new configuration of AV-apparatus network. The bus-reset signal enables the user of the AV apparatus to understand that which other AV apparatus or apparatuses his apparatus is now connected to or disconnected from. For example, the node ID (Identifier) of the user's AV apparatus is automatically changed as shown in FIGS. 1A and 1B.

Even if the configuration of AV-apparatus network remains unchanged after any AV apparatus is connected to or disconnected to any other AV apparatus, the AV apparatus will not necessarily have exactly the same node ID as before. No specific node ID can be allocated to, for example, an apparatus connected to another apparatus by a conventional SCSI (Small Computer System Interface).

Communication between the AV apparatuses is effected as the AV apparatuses exchange their node Ids. As mentioned above, each AV apparatus may not have the same node ID as before once its connection has been changed with respect to the AV apparatuses. Hence, a 64-bit GUID (Global Unique Identifier) is given to each AV apparatus. The AV apparatus can thereby be distinguished from any other AV apparatuses. Even if its node ID has been changed, each AV apparatus can be identified by its GUID.

Namely, according to the IEEE 1394 standards, each AV apparatus is identified with its type (VTR (Video Tape Recorder), MD (Mini Disc) player, tuner, or the like), its manufacturer's name (coded in the GUID), its model number (described in an ASCII (American Standard for Information Interchange) code, and the like). The user can therefore identify his AV apparatus in the network even after the node ID of the AV apparatus has been changed.

Many VTRs of the same model number may be connected together. In this case, each VTR can be identified by the GUID allocated to it. In practice, however, it would be extremely difficult for the user to identify his VTR. This is because the user can hardly remember so long a code as the 64-bit GUID. In addition, it is undesirable to display such a long code.

Suppose that only one AV apparatus of a specific model number is connected to the network. Even in this case, people who know the manufacturer, model number and the like of the AV apparatus are only those who have some knowledge of electric appliance. In other words, people who do not know much about the network, computers or the like cannot easily designate and use the AV apparatus connected to the network.

To use an AV apparatus connected to the network, a user may only input the code allocated to the apparatus, different from the codes allocated to any other AV apparatuses connected to the network. He need not know where in the network the AV apparatus is connected. To this end, the code of the AV apparatus must be stored into the AV apparatus before the user uses the apparatus. The user cannot store the code unless he has some technical knowledge. In view of this, anyone who uses the AV apparatus for the first time has to acquire the technical knowledge.

Jpn. Pat. Appln. KOKAI Publications Nos. 9-120666 and 9-154077, for example, disclose a network complying the IEEE 1394 standards. The techniques disclosed in the publications, however, do not help to solve the problem described in the preceding paragraph.

### BRIEF SUMMARY OF THE INVENTION

The present invention has been made in view of the foregoing. An object of the invention is to provide an AV apparatus which can be identified without inputting a specific code and which can therefore be easily used by those who do not know much about AV-apparatus networks or computers. Another object of the invention is to provide a method of controlling such an AV apparatus and an AV-apparatus network system.

An AV apparatus according to this invention is designed to control apparatuses and has a plurality of connection terminals to which the apparatuses can be selectively connected. Identifiers are allocated to the connection terminals, respectively. Each identifier designates a specific one of the apparatuses so that the apparatuses connected to the connection terminals are controlled in a priority order.

According to the invention, there is provided a method of controlling an AV apparatus having a plurality of connection terminals to which a plurality of apparatuses can be selectively connected, thereby to control the apparatuses connected to the connection terminals. In the method, identifiers are allocated to the connection terminals, respectively. Each identifier designates a specific one of the apparatuses so that the apparatuses connected to the connection terminals are controlled in a priority order.

According to the invention, there is provided an AV-apparatus network system comprising a plurality of AV apparatuses and a control apparatus having a plurality of connection terminals to which the AV apparatus can be connected. In the system, identifiers are allocated to the connection terminals, respectively. Each identifier designates a specific one of the apparatuses so that the apparatuses connected to the connection terminals are controlled in a priority order.

In the AV apparatus, method and system according to the invention, identifiers are allocated to the connection terminals to which specific apparatuses may be connected. Thus, the apparatuses connected to the connection terminals can be controlled in a priority order. It is therefore possible to designate the apparatuses, without necessity of inputting ID codes of the apparatuses. Hence, even people who do not know much about the network, computers or the like can easily use the apparatuses.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIGS. 1A and 1B are diagrams showing two networks, respectively, both complying with the IEEE 1394 standards;

FIG. 2 is a block diagram showing an AV apparatus according to the invention and explaining a method of controlling the AV apparatus and a network of AV apparatuses identical to the AV apparatus, both according to the invention;

FIGS. 3A and 3B shows examples of identifiers allocated to the connection terminals of the AV apparatus shown in FIG. 2;

FIG. 4 is a flowchart explaining how the initial state of the network according to the invention is confirmed;

FIGS. 5A and 5B are a flowchart explaining how a VTR is selected in the network according of this invention;

FIGS. 6A to 6F are display-screen views for explaining how a VTR is selected in the network of the invention; and

FIGS. 7A to 7D are diagrams explaining how a VTR is selected in various conditions in which VTRs are connected to an AV apparatus.

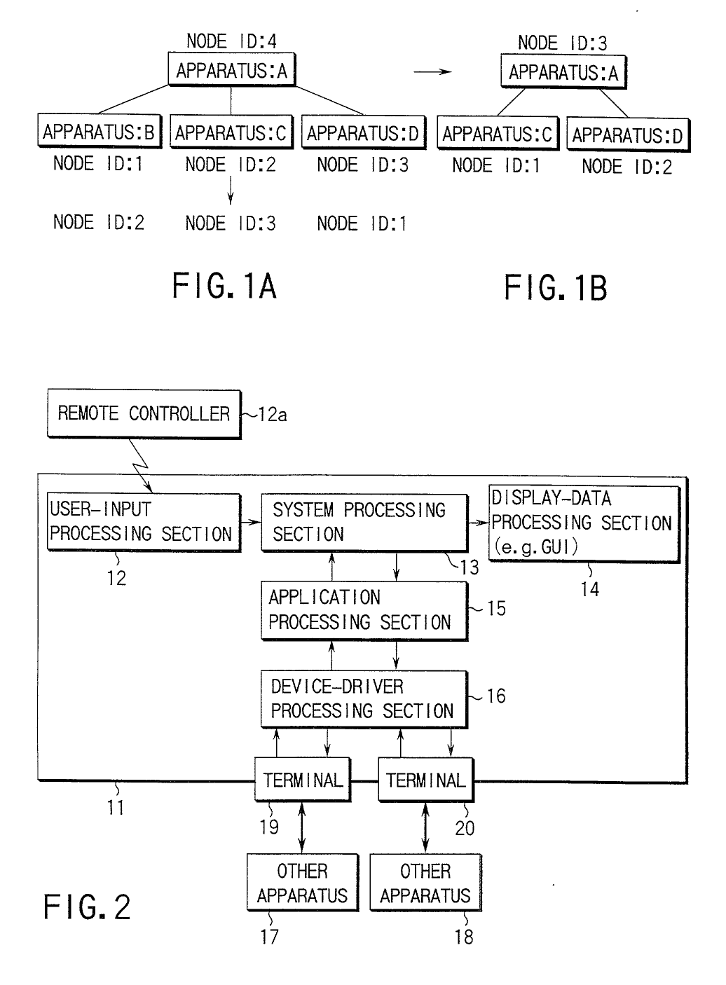

### DETAILED DESCRIPTION OF THE INVENTION

An embodiment of the present invention will be described in detail, with reference to the accompanying drawings. FIG. 2 shows an AV apparatus 11 that serves as a controller in an AV apparatus network according to the invention and which can display images. FIG. 2 also shows how the AV apparatus 11 is connected to other AV apparatuses, constituting a network.

As shown in FIG. 2, the AV apparatus 11 comprises a user-input processing section 12, a system processing section 13, a display-data processing section 14, an application processing section 15, a device-driver processing section 16, and connection terminals 19 and 20. The user-input processing section 12 receives data the user has input by operating a remote controller 12a. The system processing section 13 controls some of the other components of the AV apparatus 11. The display-data processing section 14 enables the user to operate the AV apparatus 11 by using a GUI (Graphic User Interface) or the like. The application processing section 15 and the device-driver processing section 16 are associated with the network. The connection terminals 19 and 20 connect the AV apparatus 11 to the other AV apparatuses of the network (only two AV apparatuses 17 and 18 are shown).

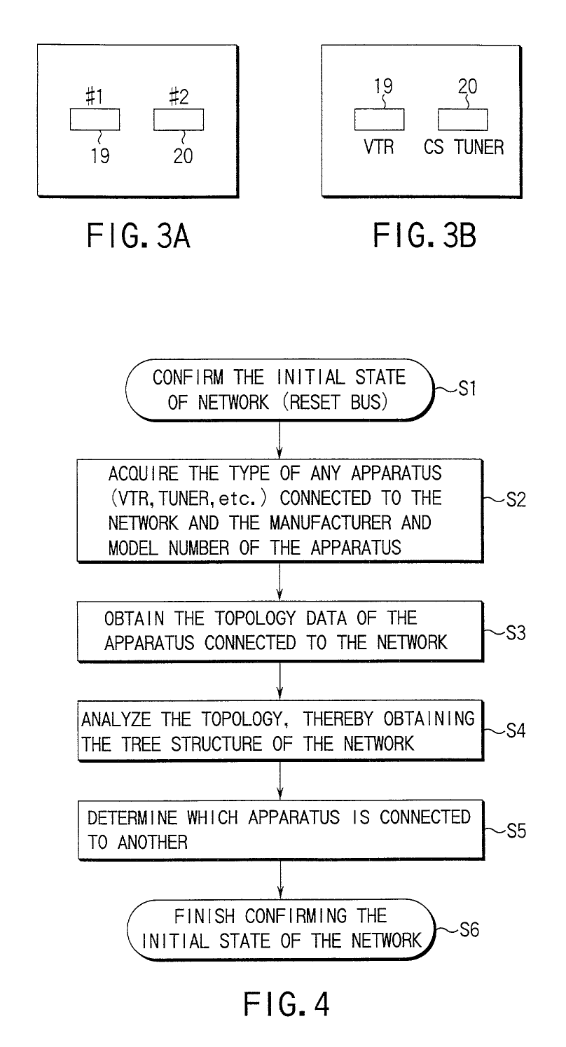

Two identifiers are allocated to the connection terminals 19 and 20 so that the user may select one of these AV apparatuses 17 and 18 and may connect the same to his AV apparatus 11. The identifiers may be numbers “#1” and “#2” as is shown in FIG. 3A. Alternatively, the identifiers may be abbreviations “VTR” and “CS tuner” as is shown in FIG. 3B, and may specify the types of the AV apparatuses 17 and 18, i.e., the VTR 17 and the CS (Communication Satellite) tuner 18. The identifiers are assigned with different priorities.

Assume that the numbers #1 and #2 are allocated to the connection terminals 19 and 20 as shown in FIG. 3A and that the number #1 has higher priority than the number #2.

In this case, the initial state of the network according to the invention is confirmed before the user starts operating the AV apparatus 11, as will be described with reference to the flowchart of FIG. 4.

In the case where IEEE 1394 serial buses are used, a bus reset signal is generated whenever the connection of AV apparatuses is altered. The connection of AV apparatuses, thus altered, is determined. On the basis of the connection determined, the topology data and the mode IDs are updated.

More specifically, the initial state of the network is confirmed at first in Step S1. Then, in Step S2, the type of any apparatus (VTR, tuner, or the like) connected to the network and the manufacturer and model number thereof are acquired. In Step S3, the topology data of the apparatuses connected to the network is obtained.

Thereafter, the topology data is analyzed in Step S4, thereby obtaining the tree structure of the network. It is then determined in Step S5 which apparatuses are connected to one another. The initial state of the network is thereby confirmed in Step S6.

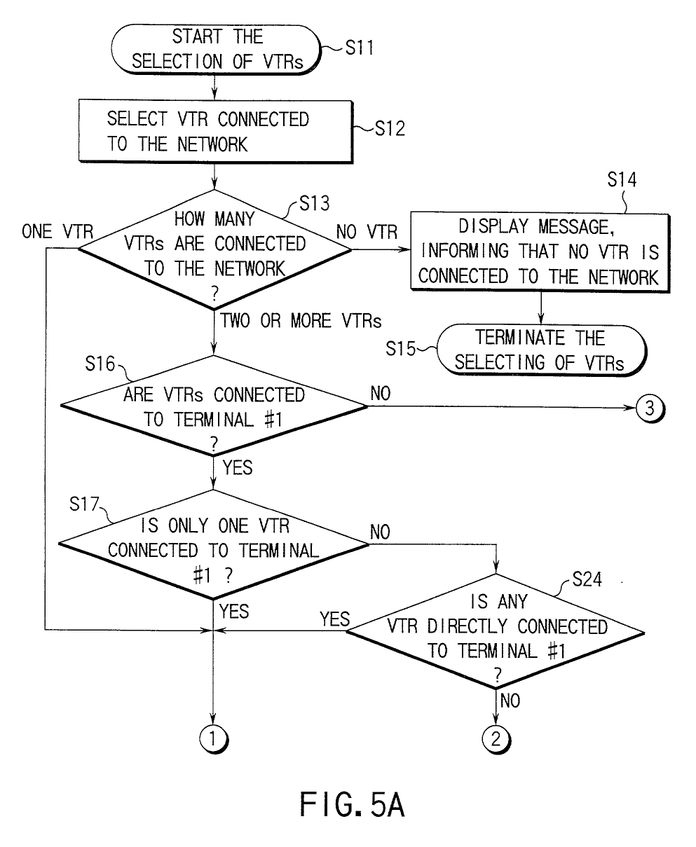

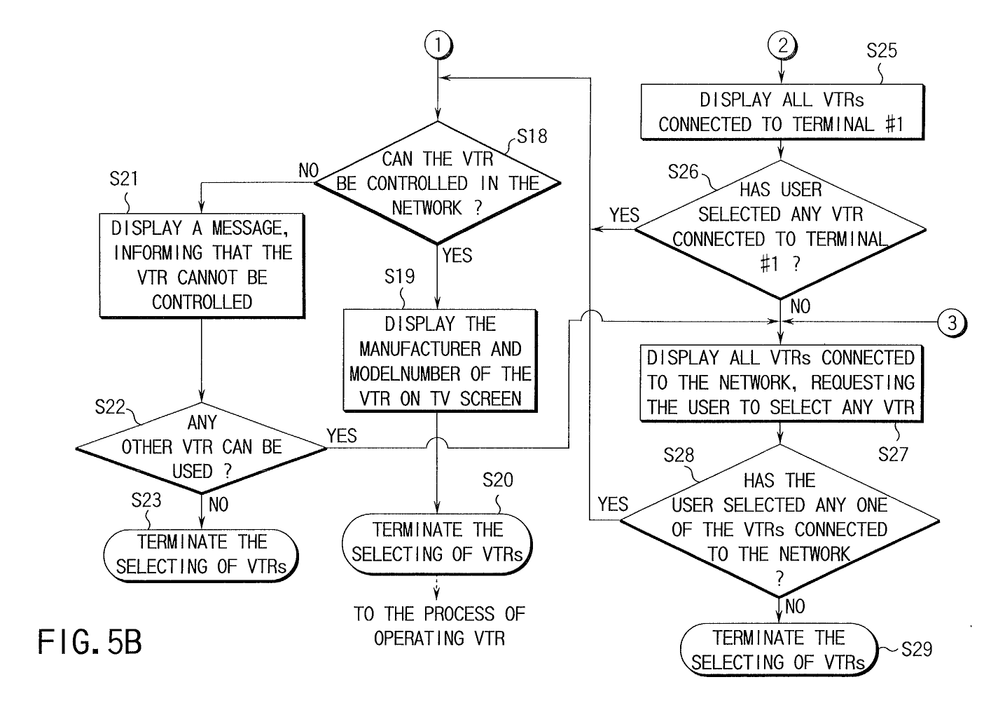

After the initial state of the network has been thus confirmed, one of the VTRs connected to the network is selected, as will be explained with reference to the flowchart of FIGS. 5A and 5B. First, the selection of VTRs is started in Step S11. In Step S12, the user selects a VTR connected to the network.

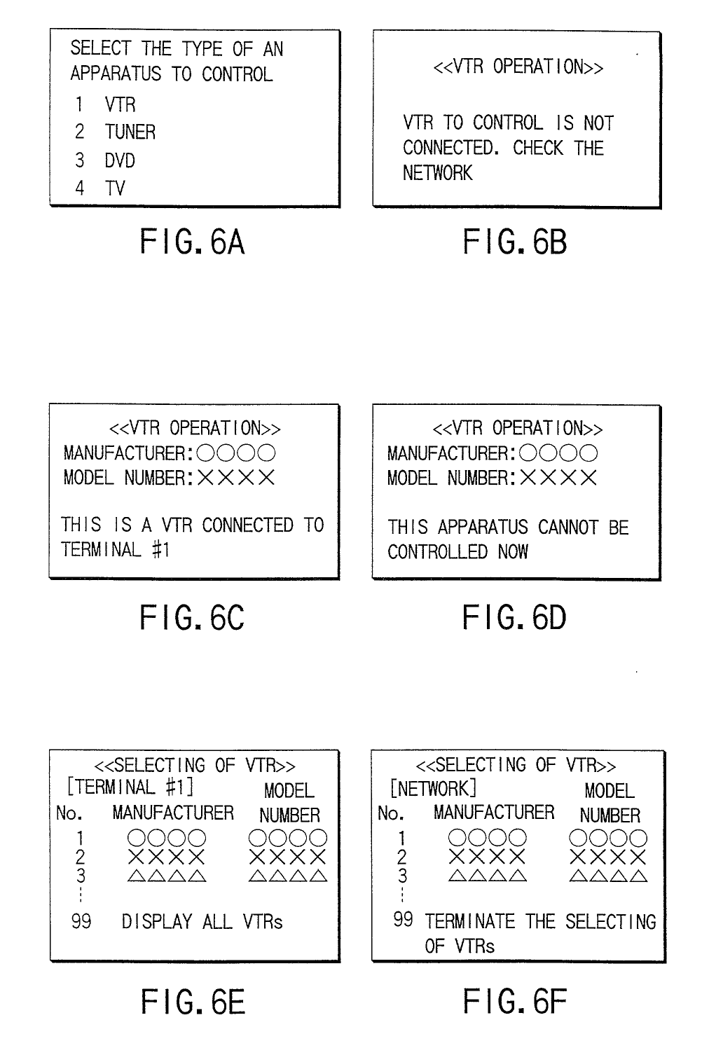

More precisely, the user depresses the network key provided on the remote controller 12a, whereby such a menu as shown in FIG. 6A is displayed on the display screen of his AV apparatus 11. The user then selects one of the menu items displayed, for example “1 VTR.” In this case, a VTR is selected, without the necessity of inputting the code allocated to the VTR.

Then, in Step S13, it is determined how many VTRs are connected to the network. If no VTRs are connected to the network, the operation goes to Step S14. In Step S14, such a message as shown in FIG. 6B is displayed on the display screen of the AV apparatus 11, informing the user that no VTRs are connected to the network. The operation then goes to Step S15, whereby the process of selecting VTRs is terminated.

In Step S13 it may be determined that two or more VTRs are connected to the network. In this case, the operation goes to Step S16. In Step S16, it is determined whether the VTRs are connected to the terminal 19 to which the number “#1” is allocated. If it is determined that the VTRs are connected to the terminal 19, the operation goes to Step S17. In Step S17, it is determined whether only one VTR is connected to the terminal 19 of the AV apparatus 11.

In Step S13 it may be determined that only one VTR is connected to the network. If this is the case, the operation jumps to Step S18. In Step S17 it may be determined that only one VTR is connected to the network. In this case, too, the operation goes to Step S18. In Step S18, it is determined whether the sole VTR connected to the network can be controlled or not.

If it is determined in Step S18 that the VTR can be operated in the network, the operation goes to Step S19. In Step S19, the manufacturer and model number of the VTR are displayed on the TV screen of the AV apparatus 11, as is illustrated in FIG. 6C. Reading the information displayed, the user understands that the very VTR he desires has been selected. Then, the process of selecting VTRs is terminated in Step S20. Thereafter, the user can operate the VTR thus selected.

To facilitate the user's understanding, various comments may be displayed on the TV screen of the AV apparatus 11. Examples of such comments are: “Only one VTR is connected to the network”; “This VTR has been selected first among three connected to the network”; and “This is the VTR you have designated.”

In Step S18 it may be determined that the sole VTR connected to the network cannot be operated at all. In this case, the operation goes to Step S21. In Step S21, the message shown in FIG. 6D is displayed on the display screen of the AV apparatus 11, informing the user that the VTR cannot be controlled and therefore cannot be used, possibly because the VTR is now recording image data.

The operation goes from Step S21 to Step S22. In Step S22, it is determined whether any other VTR can be used or not. If no other VTRs can be used, the operation goes to Step S23. In Step S23, the process of selecting VTRs is terminated.

In Step S17 it may be determined that two or more VTRs are connected to the terminal 19 of the AV apparatus 11. If this is the case, the operation goes to Step S24. In Step S24, it is determined whether any VTR is directly connected to the terminal 19 of the AV apparatus 11. If YES in Step S24, the operation goes to Step S18.

If NO in Step S24, that is, if no VTRs are directly connected to the terminal 19, the operation goes to Step S25. In Step S25, all VTRs connected to the terminal 19 are displayed on the display screen of the AV apparatus 11, as is shown in FIG. 6E, asking the user to select one of the VTRs. In Step S26, it is determined whether the user has selected one of the VTRs that are connected to the terminal 19. If YES in Step S26, the operation goes to Step S18.

In Step S26, it may be determined that the user has selected a VTR not connected to the terminal 19 of the AV apparatus 11. In Step S16, it may be determined that the VTRs are connected to the terminal 20 of the AV apparatus 11. In Step S22, it may be determined that any other VTR can be used. In any of these cases, the operation goes to Step S27. In Step S27, all VTRs connected to the network are displayed on the display screen of the of the AV apparatus 11, as is shown in FIG. 6F, requesting the user to select one of the VTRs.

In Step S28, it is determined whether the user has selected one of all VTRs that are connected to the network. If YES, the operation goes to Step S18. If NO, the operation goes to Step S29, in which the process selecting VTRs is terminated.

In the embodiment described above, the numbers #1 and #2 are allocated to the connection terminals 19 and 20, respectively, and the number #1 has higher priority than the number #2. Hence, the VTRs connected to the terminal 19 can be controlled prior to the VTRs connected to the other terminal 20. Assume that the user connects two VTRs to the terminals 19 and 20, respectively. Then, he can use the VTR connected to the terminal 19 prior to the VTR connected to the terminal 20, without inputting the ID code of the VTR connected to the terminal 19. This is helpful to those who do not have much practical knowledge of network or AV apparatuses.

Two numbers #1 and #2 are allocated to the connection terminals 19 and 20 as shown in FIG. 3A, serving as the identifiers of the terminals 19 and 20, so that the user may select one of the AV apparatuses 17 and 18 and may connect the same to his AV apparatus 11. The identifiers may be abbreviations such as “VTR” and “CS Tuner,” as shown in FIG. 3B. These identifiers may be more helpful to the user to identify the AV apparatuses 17 and 18 that should be connected to the connection terminals 19 and 20, respectively.

As described above, identifiers are allocated to the connection terminals 19 and 20 and any AV apparatus connected to the terminal 19 is controlled prior to the any AV apparatus connected to the terminal 20. In addition to this method of selecting an AV apparatus, the conventional method may be employed, in which the user inputs the ID code of a desired VTR, thereby to connect the VTR to his AV apparatus. In this case, the two methods can be switched from one to the other, which may be more convenient to the user.

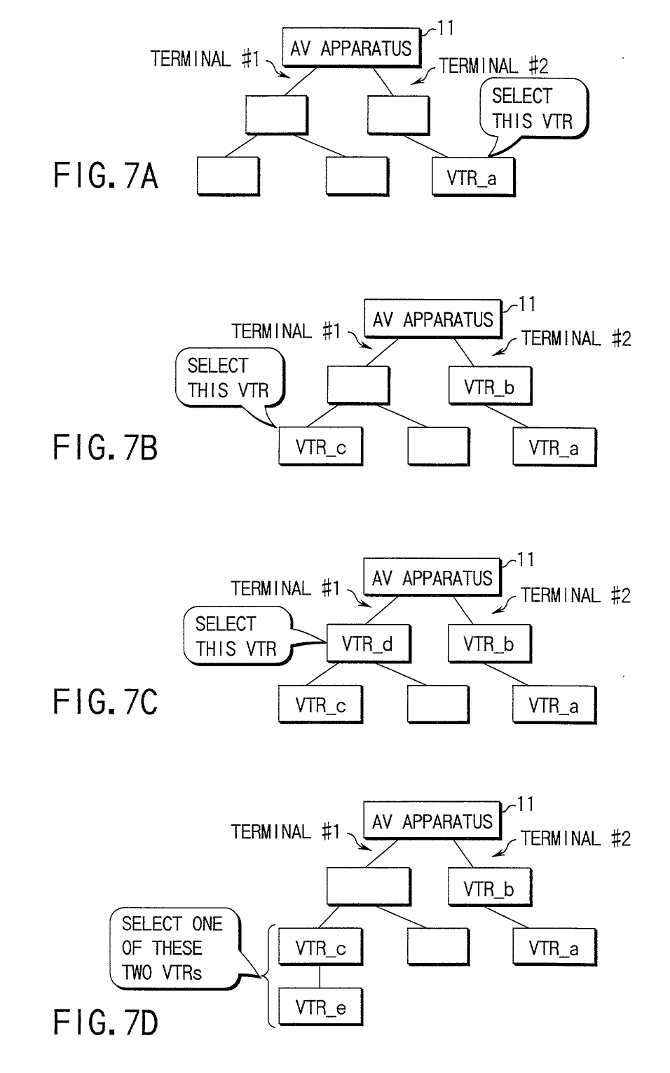

FIGS. 7A to 7D illustrate how a VTR that should be controlled prior to any others is selected as described with reference to the flowchart of FIGS. 5A and 5B, in various conditions in which VTRs are connected to the user's AV apparatus 11.

Only one VTR may be connected indirectly to the AV apparatus 11, by which ever connection terminal #1 or #2, as is illustrated in FIG. 7A. In this case, when the user selects the VTR, the VTR will be connected to the AV apparatus 11 no matter where in the network it is connected.

A VTR may be indirectly connected to the terminal #1 and two VTRs may be connected directly and indirectly to the terminal #2, as is illustrated in FIG. 7B. In this case, the VTR connected to the terminal #1 will be selected first, when the user selects a VTR.

As shown in FIG. 7C, two VTRs may be connected to the connection terminal #1, respectively directly and indirectly, and two VTRs may be connected to the connection terminal #2, respectively directly and indirectly. In this case, the VTR directly connected to the terminal #1 will be selected first, when the user selects a VTR.

As shown in FIG. 7D, two VTRs are indirectly to the connection terminal #1 and two VTRs may be connected to the connection terminal #2, respectively directly and indirectly. In this case, when the user selects a VTR, he needs to select one of the two VTRs that are indirectly connected to the terminal #1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An AV apparatus designed to control apparatuses and having a plurality of connection terminals to which the apparatuses can be selectively connected wherein identifiers are allocated to the connection terminals, respectively, each for designating a specific one of the apparatuses so that the apparatuses connected to the connection terminals are controlled in a priority order.

2. The AV apparatus according to claim 1, wherein each identifier is characters or a symbol that indicates a model number or type of the apparatus, and any apparatus designated by the identifier is controlled prior to any other apparatuses.

3. The AV apparatus according to claim 2, wherein when at least two apparatuses are connected to the same connection terminal, one of the at least two apparatuses, which is designated by the identifier allocated to the connection terminal, is selected prior to the any other of the at least two apparatuses, which is not designated by the identifier.

4. The AV apparatus according to claim 2, wherein when at least two apparatuses are connected to the same connection terminal and designated by the identifier allocated to the connection terminal, one of the at least two apparatuses directly connected to the connection terminal is selected prior to the any other of the at least two apparatuses, which is indirectly connected to the connection terminal.

5. The AV apparatus according to claim 2, wherein when an apparatus designated by a specific identifier is connected to an connection terminal to which the specific identifier is allocated, and an apparatus designated by the specific identifier is connected to an connection terminal to which the specific identifier is not allocated or to a connection terminal to which an identifier different from the specific identifier is allocated, the apparatus connected to the connection terminal to which the specific identifier is allocated is selected prior to the apparatus connected to the connection terminal to which the specific identifier is not allocated or to the connection terminal to which an identifier different from the specific identifier is allocated.

6. The AV apparatus according to any one of claims 1 to 5, wherein the connection terminals are serial bus terminals that comply with IEEE 1394 standards.

7. A method of controlling an AV apparatus having a plurality of connection terminals to which a plurality of apparatuses can be connected, thereby to control the apparatuses connected to the connection terminals, wherein identifiers are allocated to the connection terminals, respectively, each for designating a specific one of the apparatuses so that the apparatuses connected to the connection terminals are controlled in a priority order.

8. The method according to claim 7, wherein each identifier is characters or a symbol that indicates a model number or type of the apparatus, and any apparatus designated by the identifier is controlled prior to any other apparatuses.

9. The method according to claim 8, wherein when at least two apparatuses are connected to the same connection terminal, one of the at least two apparatuses, which is designated by the identifier allocated to the connection terminal, is selected prior to the any other of the at least two apparatuses, which is not designated by the identifier.

10. The method according to claim 8, wherein when at least two apparatuses are connected to the same connection terminal and designated by the identifier allocated to the connection terminal, one of the at least two apparatuses directly connected to the connection terminal is selected prior to the any other of the at least two apparatuses, which is indirectly connected to the connection terminal.

11. The method according to claim 8, wherein when an apparatus designated by a specific identifier is connected to an connection terminal to which the specific identifier is allocated, and an apparatus designated by the specific identifier is connected to an connection terminal to which the specific identifier is not allocated or to a connection terminal to which an identifier different from the specific identifier is allocated, the apparatus connected to the connection terminal to which the specific identifier is allocated is selected prior to the apparatus connected to the connection terminal to which the specific identifier is not allocated or to the connection terminal to which an identifier different from the specific identifier is allocated.

12. The method according to any one of claims 7 to 11, wherein the connection terminals are serial bus terminals that comply with IEEE 1394 standards.

13. An AV-apparatus network system comprising a plurality of AV apparatuses and a control apparatus having a plurality of connection terminals to which the AV apparatus can be connected, wherein identifiers are allocated to the connection terminals, respectively, each for designating a specific one of the apparatuses so that the apparatuses connected to the connection terminals are controlled in a priority order.

14. The system according to claim 13, wherein each identifier is characters or a symbol that indicates a model number or type of the apparatus, and any apparatus designated by the identifier is controlled prior to any other apparatuses.

15. The system according to claim 14, wherein when at least two apparatuses are connected to the same connection terminal, one of the at least two apparatuses, which is designated by the identifier allocated to the connection terminal, is selected prior to the any other of the at least two apparatuses, which is not designated by the identifier.

16. The system according to claim 14, when at least two apparatuses are connected to the same connection terminal and designated by the identifier allocated to the connection terminal, one of the at least two apparatuses directly connected to the connection terminal is selected prior to the any other of the at least two apparatuses, which is indirectly connected to the connection terminal.

17. The system according to claim 14, wherein when an apparatus designated by a specific identifier is connected to an connection terminal to which the specific identifier is allocated, and an apparatus designated by the specific identifier is connected to an connection terminal to which the specific identifier is not allocated or to a connection terminal to which an identifier different from the specific identifier is allocated, the apparatus connected to the connection terminal to which the specific identifier is allocated is selected prior to the apparatus connected to the connection terminal to which the specific identifier is not allocated or to the connection terminal to which an identifier different from the specific identifier is allocated.

18. The system according to any one of claims 13 to 17, wherein the connection terminals are serial bus terminals that comply with IEEE 1394 standards.
